(19) United States
(12) Patent Application Publication
(10) Pub. No.: US 2026/0145732 A1
(43) Pub. Date: May 28, 2026

(54) TORQUE OVERLOAD PROTECTION

(71) Applicant: HL MANDO CORPORATION, Gyeonggi-do (KR)

(72) Inventors: Raja RAMAKRISHNAN, Auburn, MI (US); Jyothis JOSEPH, Auburn, MI (US); Awab ALI, Auburn, MI (US); Tomy SEBASTIAN, Auburn, MI (US)

(21) Appl. No.: 19/341,350

(22) Filed: Sep. 26, 2025

Related U.S. Application Data
(60) Provisional application No. 63/726,102, filed on Nov. 27, 2024.

(51) Int. Cl. B62D 5/04; B62D 5/00

(52) U.S. Cl. CPC B62D 5/0463; B62D 5/008

(57) ABSTRACT

A torque overload protection method is provided. The torque overload protection being executed by a controller of a steering assembly and includes: obtaining a steering angle and a torque command being applied to a steering assembly; generating a torque adjustment command based on a steering angle overload torque repository of the controller, the torque command, and the steering angle; and using the torque adjustment command to provide overload protection for the steering assembly while the steering angle and the torque command are being applied to the steering assembly.

### CROSS REFERENCE TO PARENT APPLICATIONS

This application claims the benefit of U.S. patent application Ser. No. 63/726,102 filed on Nov. 27, 2024, entitled “OVERLOAD PROTECTION”, the entirety of which is incorporated herein by reference.

### BACKGROUND

Various embodiments of the present disclosure generally relate to a steering assembly of a motor vehicle. More particularly to the prevention of torque overload (e.g., steering torque overload) within the steering assembly.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a method for torque overload protection may comprise: obtaining a steering angle and a torque command being applied to a steering assembly; generating a torque adjustment command based on a steering angle overload torque repository of the controller, the torque command, and the steering angle; and using the torque adjustment command to provide overload protection for the steering assembly while the steering angle and the torque command are being applied to the steering assembly.

The torque adjustment command comprises an assisted torque provided by an electric motor of the steering assembly and a raw steering wheel torque applied through actuation of a steering wheel of the steering assembly.

The steering angle overload torque repository comprises an overload torque and a minimum required torque for the steering angle.

The generating of the torque adjustment command may comprise: determining that the torque command is equal to or greater than the overload torque; and generating a torque reduction command as the torque adjustment command.

The using of the torque adjustment command may comprise, while the steering assembly is being held at the steering angle: causing application of the torque reduction command to reduce a torque applied on the steering assembly from the torque command to a reduced torque that is less than the overload torque.

While the steering assembly is held at the steering angle, the torque command is reduced until the reduced torque is equal to the minimum required torque for the steering angle.

Generating the torque adjustment command may comprise: determining that the torque command is less than the overload torque; and generating a do-nothing command as the torque adjustment command to maintain the torque command while the steering assembly is being held at the steering angle.

Generating the torque adjustment command may comprise: determining that the torque command is within a predetermined threshold from the overload torque; and generating a torque reduction command as the torque adjustment command.

The steering angle overload torque repository is preprogrammed in the controller, and data contained in the steering angle overload torque repository is obtained during a calibration of the steering assembly.

The data contained within the steering angle overload torque repository is derived using one or more hysteresis plots generated during the calibration of the steering assembly, each of the one or more hysteresis plots showing a plot of steering angle versus steering torque.

According to some embodiments of the present disclosure, a steering assembly: a steering wheel assembly for steering road wheels of a motor vehicle; and a controller that is configured to: obtaining a steering angle and a torque command being applied to the steering assembly; generating a torque adjustment command based on a steering angle overload torque repository of the controller, the torque command, and the steering angle; and using the torque adjustment command to provide overload protection for the steering assembly while the steering angle and the torque command are being applied to the steering assembly.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows an example steering assembly according to one or more exemplary embodiments of the present disclosure.

FIG. 2A shows a data flow diagram illustrating a method for torque overload protection in a steering assembly according to one or more exemplary embodiments of the present disclosure.

FIGS. 2B and 2C show diagrams illustrating example hysteresis plots according to one or more exemplary embodiments of the present disclosure.

FIG. 3 shows a flow chart for illustrating a method for torque overload protection in a steering assembly according to one or more exemplary embodiments of the present disclosure.

FIG. 4 shows a block diagram of a controller of a vehicle steering system according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

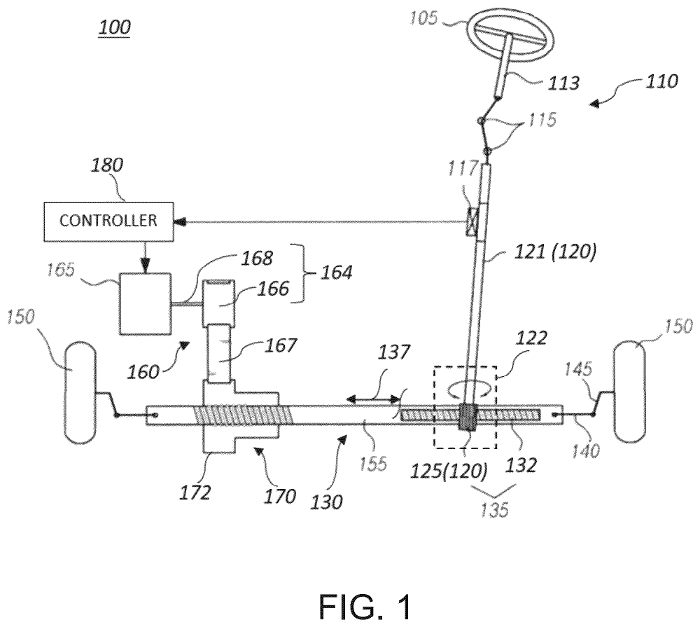

A vehicle (e.g., a motor vehicle) may be equipped with a steering assembly (see, e.g., FIG. 1). When a large amount of torque (e.g., steering torque) is applied to the steering assembly, the steering assembly is at risk of overheating, which causes components of the steering assembly to fail and/or deteriorate at a faster pace. Existing torque overload protection mechanisms that only consider torque applied over time are over restrictive and apply one or more torque reduction commands even when such torque commands are not necessary (e.g., the steering wheel can be held at a certain position and/or angle at a certain amount of torque without requiring any torque reduction). Such existing torque overload protection mechanisms are also tuned without any actual bearing (e.g., correlation) to the actual heating that occurs within the steering assembly.

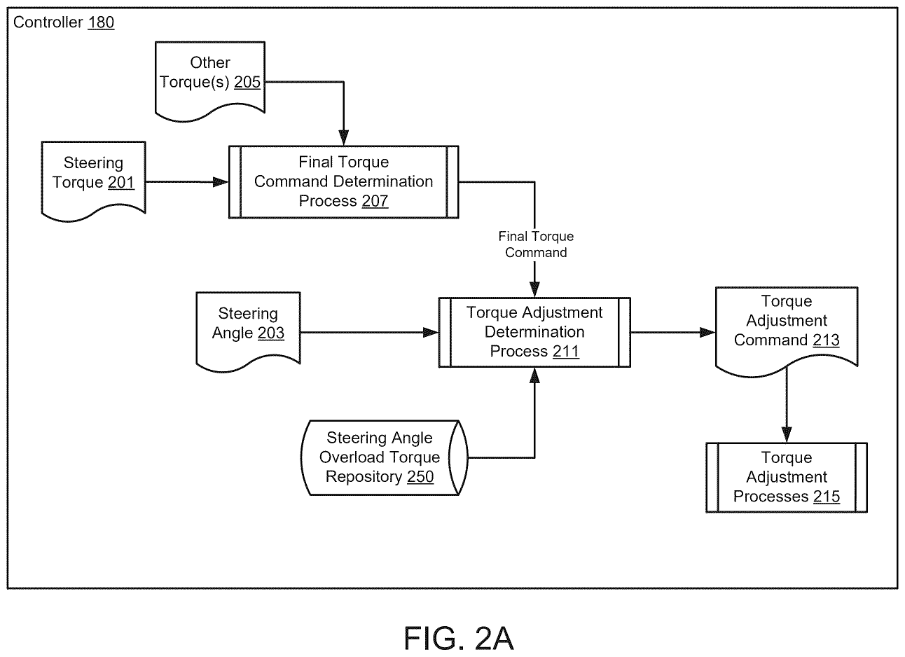

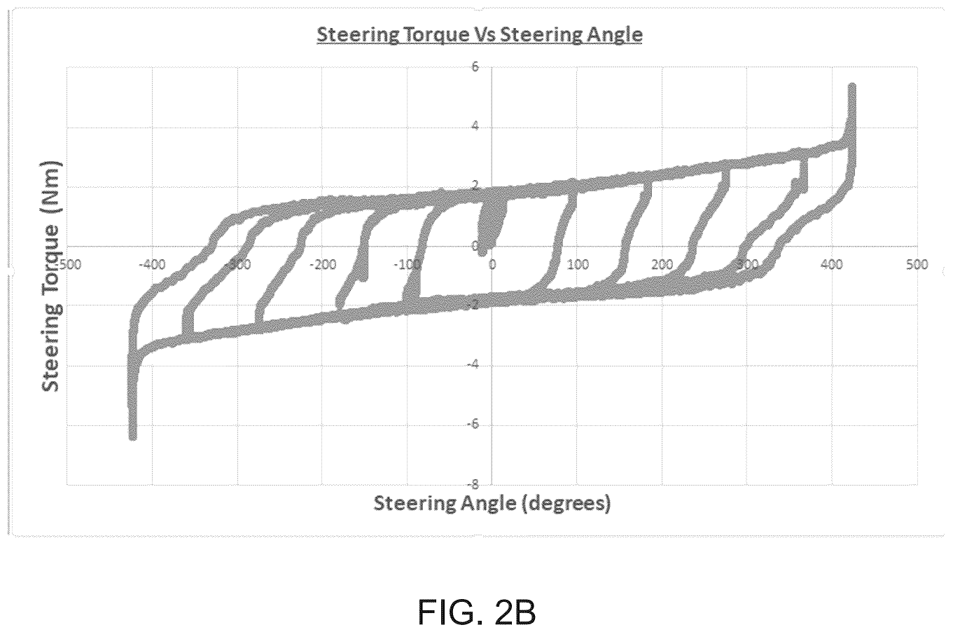

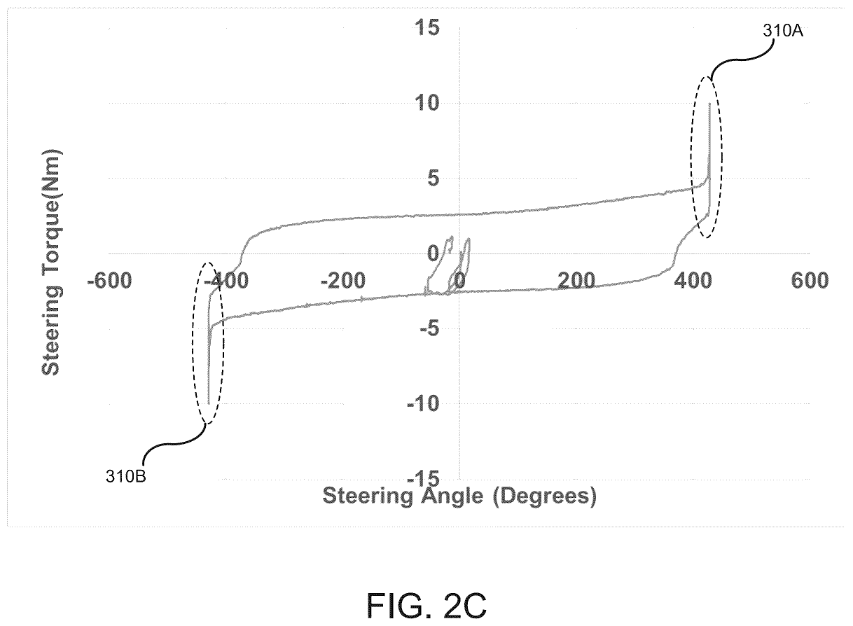

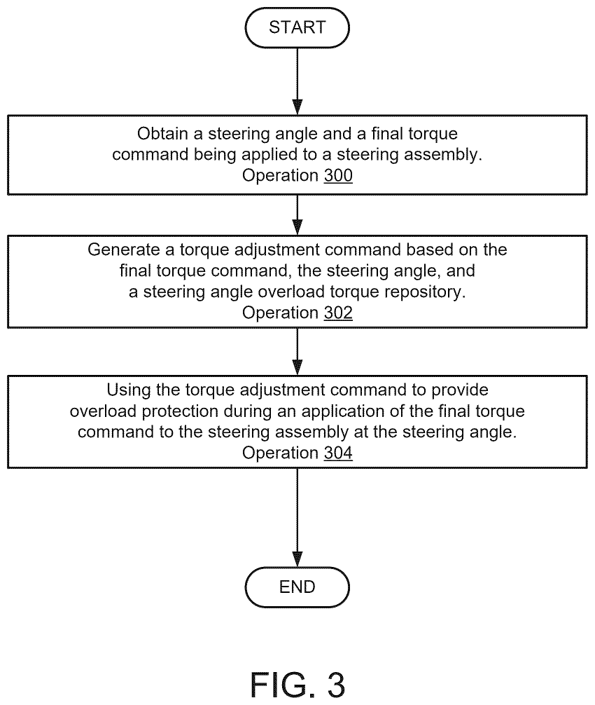

Embodiments disclosed herein overcome the above-discussed limitations and disadvantages of existing torque overload protection mechanisms that only consider torque applied over time applied. Thus, an improved torque overload protection is obtained via the torque overload protection methods of one or more embodiments discussed herein (e.g., in reference to FIGS. 2A and 3).

Referring now to FIG. 1, a steering system 100 (also referred to herein as a “steering assembly”) for use in a vehicle is illustrated. The steering system 100 allows a driver or operator of the vehicle to control the direction of the vehicle through the manipulation of the steering system 100. The steering system 100 may comprise a steering column 110, a pinion 120 including a pinion shaft 121 and a pinion gear 125, a rack assembly 130, a motor assembly 160, and a controller 180. While the steering system 100 shows the use of a pinion 120, embodiments disclosed herein are not limited thereto and may be applied to other types of steering systems including column assist steering systems or the like.

The steering column 110 provides mechanical manipulation of the vehicle's wheels in order to control the direction of the vehicle. The steering column 110 includes a steering wheel 105. The steering wheel 105 is positioned so that the driver can apply a rotational force to the steering column 110. An upper steering column shaft 113 is secured to the steering wheel 105 at one end and a column universal joint 115 at the other. The column universal joint 115 couples the upper steering column shaft 113 to the pinion shaft (or a lower steering column shaft) 121. The pinion shaft 121 may be secured to the column universal joint 115 at one end and the gear housing 122 at the other. The gear housing 122 accommodates the pinion gear 125. The pinion gear 125 of the gear housing 122 is positioned to make contact with a rack gear (such as a matching toothed portion) 132 of the rack assembly 130. The pinion gear 125 has, for example, but not limited to, helical teeth that are meshingly engaged with straight-cut teeth of the rack gear 132. The pinion gear 125, in combination with the rack gear 132, form a rack and pinion gear set 135. A rack 155 is coupled to the vehicle's steerable road wheels 150 with steering linkage. Tie rods 140 are secured to the rack assembly 130 at one end and knuckles 145 at the other.

As a rotational force is applied to the steering column 110, through the manipulation of steering wheel 105 or other applied force, the pinion gear 125 of the gear housing 122 is accordingly rotated. The movement of the pinion gear 125 causes the movement of the rack assembly 130 in the direction of arrows 137, which in turn manipulates the tie rods 140 and the knuckles 45 in order to reposition the road wheels 150. Accordingly, when the steering wheel 105 is turned, the rack and pinion gear set 135 converts the rotary motion of the steering wheel 105 into the linear motion of the rack 155.

In order to assist the driver's or operator's applied force to the steering system 100, an electric motor 165 is energized to provide power assist to the movement of the rack 155, aiding in the steering of the vehicle by the vehicle operator. The electric motor 165 may comprise a rotor 164 including a motor shaft 168 and a motor pulley 166. The electric motor 165 provides a torque force to the motor pulley 166 via the motor shaft 168. The rotation force of the motor pulley 166 is transferred to a belt 167. Alternatively, the motor pulley 166 can be directly coupled to the rack 155, or the belt 167 is replaced by a chain or gear system or any rotary that provides a rotational force to a rotary-to-linear conversion mechanism 170 (e.g. a ball-screw assembly). As a torque force is applied to the belt 167, the rotational force is converted into a linear force via the rotary-to-linear conversion mechanism 170, and the rack 155 is moved in one of the directions of arrows 137. Of course, the direction of movement of rack assembly 130 corresponds to the rotational direction of the motor pulley 166. The belt 167 and the position of the electric motor 165 allow an inner engagement surface of the belt 167 to wrap around and engage both the motor pulley 166 and a ball-screw pulley 172, that is fixed to a rotary portion (or a rotor) of the ball-screw assembly 170.

The electric motor 165 is actuated by a controller 180 that receives inputs from a torque and/or rotational position sensor(s) 117. The torque and/or rotational position sensor 117 provides a steering angle signal (also referred to herein simply as “steering angle”) to the controller 180. The torque and/or rotational position sensor 117 also provides a steering torque signal (also referred to herein simply as “steering torque”) to the controller 180.

FIG. 1 illustrate a power assist steering system (e.g., an electronic power steering (EPS)) assembly) that includes a mechanical connection between the steering wheel 105 and the rack assembly 130. Alternatively, and in applications in which a “steer-by-wire system” is employed, there is no direct mechanical connection between the steering wheel 105 and the rack assembly 130. In this application, the driver's rotational movement of the steering wheel 105 (and/or signal from an equivalent driver control device such as a joystick, pedal(s) and other mechanism for manipulation by the driver) is input into the controller 180 while the electric motor 165 provides the necessary force to manipulate the rack assembly 130.

Although a specific steering assembly is shown in FIG. 1, embodiments disclosed should not be limited to this specific steering assembly and may also be applied to other types of steering assemblies (e.g., recirculating ball steering, power steering, electronic power steering, steer-by-wire assemblies, hydraulic power steering, four-wheel steering, or the like) in which torque overload could occur. Various steering assemblies have been described in, for example, U.S. patent application Nos. Ser. No. 16/785,520 and Ser. No. 16/672,528, all of which are incorporated herein by reference in their entirety. Embodiments disclosed herein (namely, the method discussed below in reference to FIGS. 2A through 3) may be applied to any kind and/or types of these steering assemblies and/or steering systems.

Turning now to FIG. 2A, FIG. 2A shows a data flow diagram illustrating a method for torque overload protection in a steering assembly according to one or more exemplary embodiments of the present disclosure.

In this diagram of FIG. 2A, flows of data and processing of data are illustrated using different sets of shapes. A first set of shapes (e.g., 201, 203, 205, 213, etc.) is used to represent data structures (e.g., files, documents, data packets, or the like), a second set of shapes (e.g., 207, 209, 211, 215, etc.) is used to represent processes performed using and/or that generate data, a third set of shapes (e.g., 180) is used to represent physical components that perform the processes depicted suing the second set of shapes, and a third set of shapes (e.g., 250, etc.) is used to represent large scale data structures such as databases. The data flow diagram of FIG. 2A may be performed by any of the computing-related/computing-enabled components (namely, controller 180 of steering system 100) shown in FIG. 1.

In embodiments, the method for torque overload protection in the steering assembly shown in FIG. 2A may be performed (e.g., by controller 180 of the steering system 100 of FIG. 1) each time the controller 180 detects a steering action (e.g., a rotation in the steering wheel 105). The steering action may be performed by a human driver of the vehicle or by an advance driver assistance system (ADAS) (e.g., an automated driving system) (not shown) of the motor vehicle. Said another way, the controller 180 of the steering system 100 may perform the method shown in FIG. 2A each time the steering wheel is actuated during operation of the motor vehicle.

As shown in FIG. 2A, steering torque 201 may be obtained by controller 180 (e.g., from torque and/or rotational position sensor 117 of FIG. 1, or the like). This steering torque 201 may be a raw torque associated with an actuation of the steering wheel by a driver or an ADAS of the motor vehicle. Said another way, steering torque 201 does not include any other added torques (e.g., assist torque or the like) applied by electric motor 165 and may be a raw-unassisted torque as applied on the pinion shaft 121.

Other torques 205 include all additional torques that are added on top of (e.g., added to) steering torque 201 by one or more other components of the steering assembly (e.g., steering system 100 of FIG. 1) and/or of the motor vehicle. For example, one type of other torques 205 may be assist torque applied by the electric motor 165.

Steering torque 201 and other torques 205 (as obtained by the controller 180) may be ingested (e.g., by the controller 180) into final torque command determination process 207. As part of final torque command determination process 207 the steering torque 201 and other torques 205 may be combined (e.g., added together, summed up together, or the like) to generate a final torque command. Said another way, the final torque command is the sum of all torques to be applied to the steering assembly when the steering wheel 105 of the motor vehicle is actuated (e.g., during a turn, while parking, or the like) as the motor vehicle is in operation.

In embodiments, the controller 180 may also obtained (e.g., from torque and/or rotational position sensor 117 of FIG. 1, or the like) a steering angle 203 of the steering wheel 105. The steering angle 203 represents a total amount of rotation of the steering wheel 105 (and/or the pinion shaft 121 of FIG. 1 that is connected to the steering wheel 105) by the driver or by the ADAS of the motor vehicle.

The controller 180 may also maintain (e.g., store) a steering angle overload torque repository 250. The steering angle overload torque repository 250 may include acceptable torque values for a range of steering angles (e.g., −400 degrees to 400 degrees, or the like). For each steering angle, the acceptable torque values may include a range of torques between a maximum (e.g., overload) torque and a minimum required torque for maintaining a steering angle.

In embodiments the acceptable torque values may be determined (e.g., obtained) during calibration of the steering assembly (e.g., steering system 100). The calibration may be by a manufacturer and/or assembler of the steering assembly and/or motor vehicle prior to the motor vehicle being sold to an entity (e.g., an individual, a corporation, or the like). The calibration may involve generating a hysteresis plot for each steering angle included in the range of steering angles.

For example, turning first to FIG. 2B, hysteresis plots for various steering angles are overlapped over one another. As shown in the hysteresis plots of FIG. 2B, the steering angle is plotted (e.g., as the x-axis) against the steering torque (e.g., as the y-axis). The acceptable torque values for each steering angle within the range of steering angles (e.g., tested during calibration of the steering system) may be determined using these hysteresis plots shown in FIG. 2B.

In particular, turning to FIG. 2C where only a single hysteresis plot for a steering angle of 400 degrees (more specifically a steering angle of a little over 400 degrees) is shown (e.g., for the sake of brevity), an approximately positive 410 degrees steering angle would have the acceptable torque values 310A with a maximum torque of approximately 10 Nm and a minimum required torque of approximately 3 Nm. Because of the nature of the hysteresis plot, the converse angle of approximately negative 410 degrees also has a similar maximum torque of approximately 10 Nm (i.e., the absolute value of the −10 Nm shown on the graph) and a minimum required torque of approximately 3 Nm (i.e., the absolute value of the −3 Nm shown on the graph).

In embodiments, the steering angle 203 may be obtained by the controller 180 as a negative or positive value (e.g., depending on the direction of rotation from the center of the steering wheel 105 and/or of the pinion shaft 121). However, the controller 180 may use only a positive value for the steering angle 203 in processes (e.g., where all negative steering angles are converted into a positive value). Since, as shown in FIGS. 2B and 2C, the hysteresis plots are expected to be symmetrical, whether the controller 180 uses a negative steering angle as is or converts the negative steering angle into a positive steering angle should not affect the over result (e.g., should not affect the acceptable torque values for that steering angle).

Turning back to FIG. 2B, the minimum required torque for any steering angle (i.e., that is stored in steering angle overload torque repository 250) should not fall below 0 Nm even though the hysteresis plot shows that the steering torque for a given steering angle does fall below 0 Nm. For example, looking at the hysteresis plots shown in FIG. 2B, the steering angle of approximately positive 230 degrees would have a maximum torque of approximately 3 Nm and a minimum required torque of 0 Nm. Similarly, for the steering angle of approximately positive 150 degrees would have a maximum torque of 2 Nm and a minimum required torque of 0 Nm.

In embodiments, the acceptable torque values for a range of steering angles (e.g., derived from the hysteresis plots generated during the calibration of the steering assembly and/or motor vehicle) may be stored together in any fashion (e.g., as key-value pairs with the steering angle being used as the key position of the key-value pairs, as a linked list, or the like) within the steering angle overload torque repository 250.

Turning back to FIG. 2A, the final torque command (i.e., generated from final torque command determination process 207), the steering angle 203, and the information (e.g., data) included within steering angle overload torque repository 250 may be ingested into torque adjustment determination process 211 to obtain a torque adjustment command 213.

In particular, based on the obtained steering angle 203, the controller 108 may obtain the acceptable torque values (e.g., the maximum torque and the minimum required torque) from the steering angle overload torque repository 250. The final torque command may then be compared (e.g., by the controller 180) to the maximum torque to determine whether the maximum torque has been met or exceed (e.g., to determine whether the final torque command is equal to or greater than the maximum torque for the obtained steering angle 203).

If the controller 108 determines that the final torque command is equal to or greater than the maximum torque obtained from the steering angle overload torque repository 250, then the controller 108 determines that torque overload is likely and a reduction in the final torque command (e.g., a reduction of the torque applied by the motor 165 is required (e.g., using the torque adjustment command)).

If the controller 108 determines that the final torque command is lower than the maximum torque obtained from the steering angle overload torque repository 250, then the controller 180 determines that torque overload is not likely and the reduction in the final torque command is not required. Said another way, the controller 180 may issue a command for (e.g., the electric motor or the like of the steering assembly) to do nothing (e.g., as a “do-nothing command”) such that the final torque command is maintained (e.g., held as-is) while the steering angle 203 is maintained (e.g., on the steering assembly).

Alternatively, even if the final torque command is lower than the maximum torque obtained from the steering angle overload torque repository 250, the controller 180 may determine that the final torque command is still within a predetermined threshold (e.g., within 0.5 Nm from the maximum torque, or the like) from the maximum torque obtained from the steering angle overload torque repository 250. As a result, to prevent potential overheating (e.g., overload) if the steering assembly is held at this final torque command and steering angle for too long, the controller 180 may still determine that a reduction in the final torque command (e.g., a reduction of the torque applied on the steering wheel 105 and/or the pinion shaft 121) is required (e.g., using the torque adjustment command).

For example, using FIG. 2C as a reference, assume that the steering angle 203 obtained is approximately 410 degrees (e.g., negative or positive) and that the final torque command determined for this steering angle 203 is 13 Nm. Based on the hysteresis plot shown in FIG. 2C for the angle of approximately 410 degrees, this final torque command of 13 Nm has exceeded the maximum torque of 10 Nm acceptable for this steering angle. Thus, the steering assembly is likely to overheat and fail if this steering angle and final torque command is maintained for too long (e.g., 20 seconds, or any other timing/time limit based on the type and structure of the motor vehicle and/or steering assembly). As a result, the controller 108 will know at this point to start reducing the torque applied by the motor 165 (e.g., starting from the 13 Nm final torque command and stopping at the minimum required torque of approximately 3 Nm).

In embodiments, the torque adjustment commands 213 may be used by controller 108 (and/or by another controller (e.g., a chassis controller or the like) of the motor vehicle) in (e.g., torque adjustment processes 215) to adjust the torque being applied by motor 165. Using the above example of the steering angle 203 of controller 108 may adjust the torque applied by the motor 165 (i) reduce the final torque command to any torque value between the maximum torque of 10 Nm and the minimum required torque of 3 Nm; (ii) to gradually reduce the final torque command from 13 Nm to the minimum required torque of 3 Nm over a preset period of time (e.g., defined by a manufacturer of the steering assembly and/or the motor vehicle, or the like); (iii) or other similar torque adjustment processes that will reduce the final torque command under the maximum torque of 10 Nm but maintaining the torque applied on the steering wheel 105 and/or pinion shaft 121 above the minimum required torque of 3 Nm while the steering wheel 105 and/or the pinion shaft 121 is held (continuously) at the steering angle of 410 degrees (e.g., negative or positive).

Such torque overload protection of embodiments disclosed herein that utilizes the steering angle 203 as a factor overcomes the limitations of existing torque overload protection mechanisms that only consider torque applied over time applied since a final torque command for a specific steering angle need not be unnecessarily reduced if that final torque command does not exceed the maximum (e.g., overload) torque associated with that specific steering angle. This also directly prevents any overheating in the steering assembly should the final torque command does exceed the maximum (e.g., overload) torque or is held for too long at value that exceeds the maximum (e.g., overload) torque (i.e., for each specific measured steering angle).

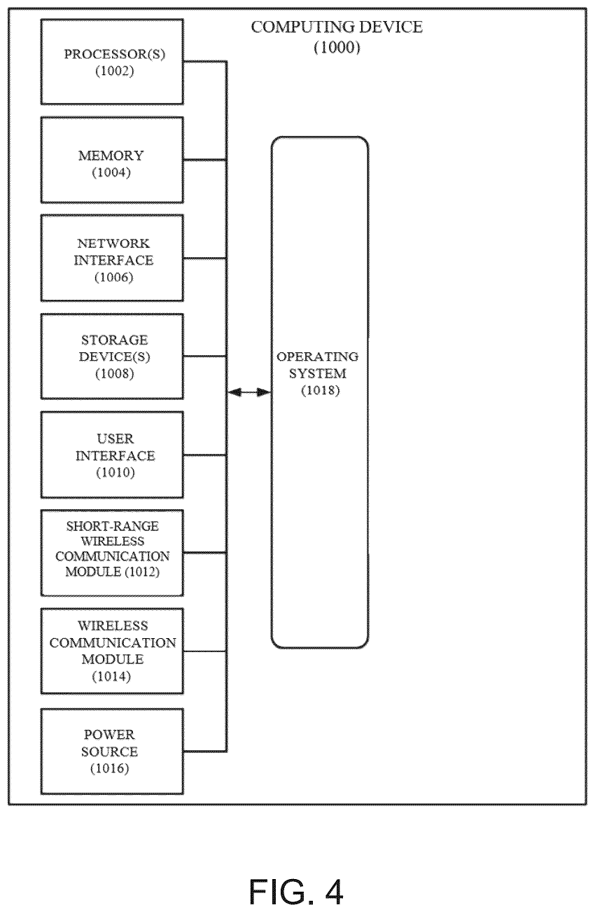

Any of the processes illustrated using the second set of shapes (shown in FIG. 2A) may be performed, in part or whole, by digital processors (e.g., central processors, processor cores, etc.) that execute corresponding instructions (e.g., computer code/software) of controller 180 (see also, e.g., FIG. 4 for more details). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components of the controller 180 such as digital signal processors, application specific integrated circuits, programmable gate arrays, graphics processing units, data processing units, and/or other types of hardware components (see also, e.g., FIG. 4 for more details). These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIG. 3, a flowchart illustrating a method for torque overload protection in the steering assembly according to one or more exemplary embodiments of the present disclosure. The operations of the flowchart of FIG. 3 may be performed, for example, by the controller 180 of the steering system 100 of FIG. 1. Although shown as a series of temporal steps, the operations of the flowchart 3 need not be performed in the exact order shown in FIG. 3 and any of the operations can be performed in any order without departing from the scope and spirit of embodiments disclosed herein.

At Operation 300, and as discussed above in reference to FIGS. 2A-2C, the controller 108 may obtain a steering angle (e.g., 203, FIG. 2A) and a final torque command (e.g., as generated using final torque command determination process 207 of FIG. 2A) being applied to a steering assembly (e.g., 100, FIG. 1).

At Operation 302, and as discussed above in refernce to FIGS. 2A-2C, the controller 180 may generate a torque adjustment command (e.g., 213, FIG. 2A) based on the final torque command, the steering angle, and a steering angle overload torque repository (e.g., 250, FIG. 2A). In embodiments, the steering angle overload torque repository may be preloaded (e.g., preprogrammed) within a memory of the controller 180.

At Operation 304, and as discussed above in refernce to FIGS. 2A-2C, the controller 180 may use the torque adjustment command to provide overload protection during an application of the final torque command (at the obtained steering angle associated with the final torque command) to the steering assembly.

The method of FIG. 3 may end following Operation 304.

FIG. 4 shows a block diagram illustrating components of an example computing device, such as the controller 180 shown in FIG. 1. FIG. 4 illustrates only one particular example of the controller 180, and many other examples of the controller 180 may be used in other instances.

As shown in the specific example of FIG. 4, a computing device 1000, such as the controller 180 shown in FIG. 1, may include one or more processors 1002, memory 1004, network interface 1006, one or more storage devices 1008, user interface 1010, short-range wireless communication module 1012, wireless communication module 1014, and power source 1016. Computing device 1000 may also include operating system 1018, which may include modules and/or applications that are executable by one or more processors 1002 and computing device 1000. Each of the components 1002, 1004, 1006, 1008, 1010, 1012, 1014, 1016, and 1018 may be interconnected (physically, communicatively, and/or operatively) for inter-component communications.

One or more processors 1002, in one example, may be configured to implement functionality and/or process instructions for execution within computing device 1000. For example, one or more processors 1002 may be capable of processing instructions stored in memory 1004 or instructions stored on one or more storage devices 1008. These instructions may define or otherwise control the operation of operating system 1018.

Memory 1004 may, in one example, be configured to store information within computing device 1000 during operation. Memory 1004, in some examples, may be described as a computer-readable storage medium. In some examples, memory 1004 may be a temporary memory, meaning that a primary purpose of memory 1004 is not long-term storage. Memory 1004 may, in some examples, be described as a volatile memory, meaning that memory 1004 does not maintain stored contents when computing device 1000 is turned off. Examples of volatile memories may include random access memories (RAM), dynamic random access memories (DRAM), static random access memories (SRAM), and other forms of volatile memories known in the art. In some examples, memory 1004 may be used to store program instructions for execution by one or more processors 1002. Memory 1004 may, in one example, be used by software or applications running on computing device 1000 to temporarily store information during program execution.

One or more storage devices 1008 may, in some examples, also include one or more computer-readable storage media. One or more storage devices 1008 may be configured to store larger amounts of information than memory 1004. One or more storage devices 1008 may further be configured for long-term storage of information. In some examples, one or more storage devices 1008 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Computing device 1000 may, in some examples, also include network interface 306. Computing device 1000 may, in one example, use network interface 306 to communicate with external devices via one or more networks. Network interface 506 may be a network interface card, such as an Ethernet card, an optical transceiver, a radio frequency transceiver, or any other type of device that can send and receive information. Other examples of such network interfaces may include Bluetooth, 5G and Wi-Fi radios in mobile computing devices as well as universal serial bus (USB). In some examples, computing device 1000 may the network interface 1006 to wirelessly communicate with an external device such as a server, mobile phone, or other networked computing device.

Computing device 1000 may, in one example, also include user interface 1010. User interface 1010 may be configured to receive input from a user (e.g., tactile, audio, or video feedback). User interface 1010 may include a touch-sensitive and/or a presence-sensitive screen or display, mouse, a keyboard, a voice responsive system, or any other type of device for detecting a command from a user. In some examples, user interface 1010 may include a touch-sensitive screen, mouse, keyboard, microphone, or camera.

User interface 1010 may also include, combined or separate from input devices, output devices. In this manner, user interface 1010 may be configured to provide output to a user using tactile, audio, or video stimuli. In one example, user interface 1010 may include a touch-sensitive screen or display, sound card, a video graphics adapter card, or any other type of device for converting a signal into an appropriate form understandable to humans or machines. In addition, user interface 1010 may include a speaker, a cathode ray tube (CRT) monitor, a liquid crystal display (LCD), or any other type of device that can generate intelligible output to a user.

Computing device 1000, in some examples, may include power source 1016, which may be a rechargeable battery and may provide power to computing device 1000. Power source 1016 may, in some examples, be a battery made from nickel-cadmium, lithium-ion, or other suitable material. In other examples, power source 1016 may be a power source capable of providing stored power or voltage from another power source.

In addition, computing device 1000 may include short-range wireless communication module 1012. Short-range wireless communication module 1012 may be active hardware that is configured to communicate with other short-range wireless communication modules. Examples of short-range wireless communication module 1012 may include an NFC module, an RFID module, and the like. In general, short-range wireless communication module 1012 may be configured to communicate wirelessly with other devices in physical proximity to short-range wireless communication module 1012 (e.g., less than approximately ten centimeters, or less than approximately four centimeters). In other examples, short-range wireless communication module 1012 may be replaced with an alternative short-range communication device configured to communicate with and receive data from other short-range communication devices. These alternative short-range communication devices may operate according to Bluetooth, Ultra-Wideband radio, or other similar protocols. In some examples, short-range wireless communication module 1012 may be an external hardware module that is coupled with computing device 1000 via a bus (such as via a Universal Serial Bus (USB) port). short-range wireless communication module 1012, in some examples, may also include software which may, in some examples, be independent from operating system 1018, and which may, in some other examples, be a sub-routine of operating system 1018.

The computing device 1000, in some examples, may also include wireless communication module 1014. Wireless communication module 1014 may, in some examples, may be a device operable to exchange data with other wireless communication modules over short distances (e.g., less than or equal to ten meters). Examples of wireless communication module 1014 may include a Bluetooth module, a WiFi direct module, and the like.

Computing device 1000 may also include operating system 1018. Operating system 1018 may, in some examples, control the operation of components of computing device 1000. For example, operating system 1018 may, in one example, facilitate the interaction with one or more processors 1002, memory 1004, network interface 1006, one or more storage devices 1008, user interface 1010, short-range wireless communication module 1012, wireless communication module 1014, and power source 1016.

Any applications implemented within or executed by computing device 1000 may be implemented or contained within, operable by, executed by, and/or be operatively/communicatively coupled to components of computing device 1000 (e.g., one or more processors 1002, memory 1004, network interface 1006, one or more storage devices 1008, user interface 1010, short-range wireless communication module 1012, wireless communication module 1014, and/or power source 1016).

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method configured to be executed by a controller of a steering assembly, the method comprising:
obtaining a steering angle and a torque command being applied to a steering assembly;
generating a torque adjustment command based on a steering angle overload torque repository of the controller, the torque command, and the steering angle; and
using the torque adjustment command to provide overload protection for the steering assembly while the steering angle and the torque command are being applied to the steering assembly.

2. The method of claim 1, wherein the torque adjustment command comprises an assisted torque provided by an electric motor of the steering assembly and a raw steering wheel torque applied through actuation of a steering wheel of the steering assembly.

3. The method of claim 2, wherein the steering angle overload torque repository comprises an overload torque and a minimum required torque for the steering angle.

4. The method of claim 3, wherein the generating of the torque adjustment command comprises:
determining that the torque command is equal to or greater than the overload torque; and
generating a torque reduction command as the torque adjustment command.

5. The method of claim 4, wherein the using of the torque adjustment command comprises, while the steering assembly is being held at the steering angle:
causing application of the torque reduction command to reduce a torque applied on the steering assembly from the torque command to a reduced torque that is less than the overload torque.

6. The method of claim 5, wherein, while the steering assembly is held at the steering angle, the torque command is reduced until the reduced torque is equal to the minimum required torque for the steering angle.

7. The method of claim 3, wherein generating the torque adjustment command comprises:
determining that the torque command is less than the overload torque; and
generating a do-nothing command as the torque adjustment command to maintain the torque command while the steering assembly is being held at the steering angle.

8. The method of claim 3, wherein generating the torque adjustment command comprises:
determining that the torque command is within a predetermined threshold from the overload torque; and
generating a torque reduction command as the torque adjustment command.

9. The method of claim 2, wherein the steering angle overload torque repository is preprogrammed in the controller, and data contained in the steering angle overload torque repository is obtained during a calibration of the steering assembly.

10. The method of claim 9, wherein the data contained within the steering angle overload torque repository is derived using one or more hysteresis plots generated during the calibration of the steering assembly, each of the one or more hysteresis plots showing a plot of steering angle versus steering torque.

11. A steering assembly comprising:
a steering wheel assembly for steering road wheels of a motor vehicle; and
a controller that is configured to:
obtaining a steering angle and a torque command being applied to the steering assembly;
generating a torque adjustment command based on a steering angle overload torque repository of the controller, the torque command, and the steering angle; and
using the torque adjustment command to provide overload protection for the steering assembly while the steering angle and the torque command are being applied to the steering assembly.

12. The steering assembly of claim 11, wherein the torque adjustment command comprises an assisted torque provided by an electric motor of the steering assembly and a raw steering wheel torque applied through actuation of a steering wheel of the steering assembly.

13. The steering assembly of claim 12, wherein the steering angle overload torque repository comprises an overload torque and a minimum required torque for the steering angle.

14. The steering assembly of claim 13, wherein the generating of the torque adjustment command comprises:
determining that the torque command is equal to or greater than the overload torque; and
generating a torque reduction command as the torque adjustment command.

15. The steering assembly of claim 14, wherein the using of the torque adjustment command comprises, while the steering assembly is being held at the steering angle:
causing application of the torque reduction command to reduce a torque applied on the steering assembly from the torque command to a reduced torque that is less than the overload torque.

16. The steering assembly of claim 15, wherein, while the steering assembly is held at the steering angle, the torque command is reduced until the reduced torque is equal to the minimum required torque for the steering angle.

17. The steering assembly of claim 13, wherein generating the torque adjustment command comprises:
determining that the torque command is less than the overload torque; and
generating a do-nothing command as the torque adjustment command to maintain the torque command while the steering assembly is being held at the steering angle.

18. The steering assembly of claim 13, wherein generating the torque adjustment command comprises:
determining that the torque command is within a predetermined threshold from the overload torque; and
generating a torque reduction command as the torque adjustment command.

19. The steering assembly of claim 12, wherein the steering angle overload torque repository is preprogrammed in the controller, and data contained in the steering angle overload torque repository is obtained during a calibration of the steering assembly.

20. The steering assembly of claim 19, wherein the data contained within the steering angle overload torque repository is derived using one or more hysteresis plots generated during the calibration of the steering assembly, each of the one or more hysteresis plots showing a plot of steering angle versus steering torque.
